(19) United States
(12) Patent Application Publication
(10) Pub. No.: US 2026/0099886 A1
(43) Pub. Date: Apr. 9, 2026

(54) SYSTEMS AND METHODS FOR DISTRIBUTION OF FUNDS

(71) Applicant: The PNC Financial Services Group, Inc., Pittsburgh, PA (US)

(72) Inventors: William Albert BROWN, Pittsburgh, PA (US); Beth Marie Klebacha, Gibsonia, PA (US); Saurabh JOSHI, Mars, PA (US); Ryan Daniel Kneidel, Bellevue, PA (US)

(73) Assignee: The PNC Financial Services Group, Inc., Pittsburgh, PA (US)

(21) Appl. No.: 19/417,992

(22) Filed: Dec. 12, 2025

Related U.S. Application Data
(63) Continuation of application No. 18/744,885, filed on Jun. 17, 2024.
(60) Provisional application No. 63/615,988, filed on Dec. 29, 2023.

(51) Int. Cl. G06Q 40/12; G06Q 20/10; G06Q 20/34

(52) U.S. Cl. CPC G06Q 40/12; G06Q 20/10; G06Q 20/351

(57) ABSTRACT

A computer-implemented method and system for managing the distribution of funds received from an organization's corporate account to virtual card holders as participants of the organization. The methods and systems may include managing distributing funds to team accounts and further distributing funds received to virtual cards of each of the participants. The methods and systems may include collecting the remaining balance of funds from the virtual cards when certain termination criterion are met.

### CROSS REFERENCE TO RELATED APPLICATIONS

This application is based upon and claims the benefit of priority of prior U.S. Provisional Ser. No. 63/615,988 , filed on Dec. 29, 2023, the contents of which are incorporated herein by reference in its entirety.

### TECHNICAL FIELD

The present disclosure generally relates to systems and methods for the distribution of funds from corporate accounts to participants'virtual cards. More specifically, and without limitation, the present disclosure relates to improvements on systems and methods of managing the distribution of funds received from corporate accounts to at least one team accounts and further distribution of funds from each of the at least one team accounts to at least one virtual cards associated with at least one participants. The improvements on systems and methods of managing the distribution of funds received also may include collecting the remaining balance from the virtual cards upon the trigger of some event condition and returning the funds to the appropriate originating team accounts and/or corporate account.

### BACKGROUND

Distribution of funds for organizations with a large number of participants has been a long-lasting pain point. Distributing funds presents unique challenges to financial institutions as well as organizational participants. As a non-limiting example, organizations such as colleges and university systems have unique considerations. For example, university administrators may want to open bank accounts for student athletes. Typical schemes for managing such accounts have long been associated with either the presentation of cash or physical cards, with prepaid funds loaded onto the cards prior to sending out the physical cards. Additionally, university administrators may want the funds to be distributed based on a predetermined criterion such as being available only for a specific time period or limiting the use of any funds to specific purposes. Due to the potential limits of this scenario, there exists unnecessary technical complexity for both institutions and banks. On the university side, the complexity creates many technical inconveniences, for example, by necessitating the collection of a large amount of data from students and filling out a large number of applications for the physical cards. On the bank side, the complexity creates many separate technical inconveniences, for example, this scenario may incur the production of physical cards for each of the student athletes, involving unnecessary production costs. Additionally, the bank side may present unique challenges related to associating credit limits with student accounts. Existing solutions may allow students to open a student account that does not require a minimum to fund an account. However, these solutions do not consider that a university may be the distributor of funds and may have restrictions on the funds in how they may be used. Furthermore, existing systems and methods for managing the distribution of funds based on archaic physical transactions tied to either cash in-hand or preloaded physical cards lack the convenience and use of modern digital applications.

As a non-limiting example, consider the distribution of funds by a university administrator to its student athletes. Certain rules governing compensation to student athletes may limit the use of funds for specific activities such as payments toward an athlete's academic costs, travel expenses, and on-campus dining. Offering preloaded, physical cards prevents a centralized method of tracking student expenditures in real-time. In contrast, a centralized management scheme associating a student athlete to a specific virtual card allows for convenient use by the student athlete while affording university administrators the ease of distributing funds and tracking expenditures.

Should a student athlete spend money outside the appropriate bounds of the virtual card, the virtual card distribution methods and system described herein allow the university administrator to collect a refunded amount seamlessly. Additionally, the distribution methods and system described herein may be established to prevent the student athlete (or any other student) from spending funds on certain transactions. Unlike physical cards, where determinations on spending limits may only be established prior to handing out the physical cards, the use of the virtual cards distribution system and methods gives the user, such as the university administrator, flexibility to establish these preset determinations. The virtual cards distribution system also allows flexibility to adapt and change the rules and limits of virtual card spending based on the needs of the university administrator and virtual card users.

Other distribution methods and systems using virtual cards may exist, but such methods and systems nonetheless present drawbacks of their own. For example, such systems and methods may consolidate funds from several different sources without proper tracing rules attached to the funds. The result hampers an overseeing entity from efficiently being able to reallocate funds among several team entities after a user of the systems and methods partially expends such funds. Reallocation thus becomes time intensive, tedious, and requires extensive manual intervention. Such reallocation becomes increasingly complex, when the users of the systems and methods continue to use the funds without some intervening act.

Accordingly, there is a need to overcome these and other drawbacks of existing systems and methods for improved systems and methods for managing the distribution of funds. The present disclosure provides a solution to distribute funds from a corporate account to a participant's virtual card and automatically collects the remaining balance from a participant's virtual card to either the associated originating source team accounts and/or the originating source corporate account. Furthermore, the disclosed invention distributes funds from a corporate account to at least one team accounts associated with an organization, such as a university account, and further distributes funds from each team account to each of participants'virtual cards.

### SUMMARY

In view of the foregoing, embodiments of the present disclosure address disadvantages of existing systems and methods by providing novel computer-implemented systems and methods for managing the distribution of funds.

Embodiments of the present disclosure provide a computer-implemented system for managing distribution of funds received. The funds distribution management system may include a memory storing a set of instructions. The funds distribution management system may include a database in electronic communication with the memory. The funds distribution management system may include a plurality of processors in electronic communication with the database. The database may be configured to store information that comprises corporate account information, team account information, participant information, and account balance information. The corporate account information may be associated with a corporate account and team account information may be associated with at least one team accounts. The participant information may be associated with at least one participants, and the account balance information may be associated with at least one virtual cards. The plurality of processors may be configured to execute a set of instructions. The set of instructions may include associating the at least one participants with the corporate account based on the access rights of the at least one participants, wherein the at least one participants may be a currently registered member of the organization that owns the corporate account. The set of instructions may include associating an at least one parameter with the corporate account, wherein the at least one parameter updates the at least one team accounts, wherein the database may update based on the updates to the at least one team accounts. The set of instructions may include associating the at least one parameter from the at least one team accounts to the at least one virtual cards, wherein each of the at least one virtual cards may be associated with the at least one participants and the database may update based on the associating. The set of instructions may include determining whether a termination criterion may trigger. The set of instructions may include updating a status and a value of the at least one parameter in the database. The set of instructions may include termination criterion, wherein the termination criterion may be predetermined by the system.

According to embodiments of the present disclosure, a database may update account balance information automatically, or based on an input received in response to a prompt to the at least one participants.

According to embodiments of the present disclosure, account balance information may be accessible and displayed to a participant using a computerized device, wherein a computerized device may be any of a personal computer, mobile device, wearable device, or Internet of Things (IoT) device.

According to embodiments of the present disclosure, the at least one team accounts may be managed by a bank or a virtual card service provider.

According to embodiments of the present disclosure, the at least one virtual cards may be associated with at least two team accounts.

According to embodiments of the present disclosure, the termination criterion may trigger collection from the at least one virtual cards associated with the at least two team accounts. Collection from the at least one virtual cards may include determining an original distribution of funds to the at least one virtual cards from each of the at least two team accounts. Collection from the at least one virtual cards may include determining a remaining balance of funds to the at least one virtual cards from each of the at least two team accounts. Collection from the at least one virtual cards may include collecting the remaining balance of funds from the at least one virtual cards. Collection from the at least one virtual cards may include distributing the remaining balance of funds received based on the difference between the original distribution of funds and the remaining balance of funds to each of the at least two team accounts.

According to embodiments of the present disclosure, distributing the balance of remaining funds received for each of the at least two team accounts may be based on a policy.

According to embodiments of the present disclosure, the termination criterion may be a specific data or deregistration of a participant from the corporate account.

According to embodiments of the present disclosure, the updating the status and the value of the at least one parameter in the database may include the amount of funds transferred to the at least one team accounts, the corporate account number for where the funds originated, the corporate account number for where the funds distributed, and the time of the distribution.

According to embodiments of the present disclosure, the updating the status and the value of the at least one parameter in the database may include the amount of funds transferred to the at least one virtual cards, the team account number for where the funds originated, the team account number for where the funds distributed, and the time of the distribution.

Embodiments of the present disclosure provide a computer-implemented method for managing the distribution of funds. The method may include associating an at least one participants with a corporate account based on the access rights of the at least one participants, wherein the at least one participants may be a currently registered member of the organization that owns the corporate account. The method may include associating an at least one parameter with the corporate account, wherein the at least one parameter updates to the at least one team accounts, wherein the updates to the at least one team accounts may be updated in a database. The method may include associating the at least one parameter from the at least one team accounts to an at least one of virtual cards, wherein the at least one parameter to the at least one virtual cards may be associated with the at least one participants and the database may be updated based on the associating. The method may include determining whether a termination criterion has been triggered, wherein the termination criterion may be predetermined. The method may comprise updating a status and a value of the at least one parameter in the database upon determining the termination criterion may be met.

Embodiments of the present disclosure provide a tangible, non-transitory computer-readable memory device that stores a set of instructions. The set of instructions, when executed by at least one processor, cause the at least one processor to perform operations for managing the distribution of funds. The operations may include associating an at least one participants with a corporate account based on the access rights of the at least one participants, wherein the at least one participants may be a currently registered member of the organization that owns the corporate account. The operations may include associating an at least one parameter with the corporate account, wherein the at least one parameter updates an at least one team accounts, wherein the updates to the at least one team accounts may update in a database. The operations may include associating the at least one parameter from the at least one team accounts to an at least one of virtual cards, wherein the at least one parameter to the at least one virtual cards may be associated with the at least one participants and the database may update based on the associating. The operations may include determining whether a termination criterion has been triggered, wherein the termination criterion may be predetermined. The operations may comprise updating a status and a value of the at least one parameter in the database upon determining the termination criterion may be met.

The systems and methods disclosed herein may be used in various applications and systems, such as business and financial systems and systems that benefit from managing a plurality of accounts.

It is to be understood that the foregoing general description and the following detailed description are exemplary and explanatory only and are not restrictive of the disclosed embodiments.

### BRIEF DESCRIPTION OF DRAWINGS

Embodiments and various aspects of the present disclosure are illustrated in the following detailed description and the accompanying figures. Various features shown in the figures are not drawn to scale. Identical reference numerals generally represent identical components in the exemplary implementations of the present disclosure. In the drawings:

FIG. 1 illustrates an exemplary problem for managing the distribution of funds received, consistent with the disclosed embodiments.

FIG. 2 illustrates an exemplary solution for managing the distribution of funds received, consistent with the disclosed embodiments.

FIG. 3 is a block diagram of an exemplary system for managing the distribution of funds received, consistent with disclosed embodiments.

FIG. 4 is a block diagram showing an example computing device, consistent with disclosed embodiments.

FIG. 5 is a flowchart of an exemplary process for managing the distribution of funds received, consistent with disclosed embodiments.

FIG. 6 is a diagram showing a topological structure, consistent with disclosed embodiments.

FIG. 7 is an illustrative diagram showing exemplary transactions between funds accounts and virtual cards consistent with disclosed embodiments.

FIG. 8 is an illustrative diagram showing exemplary transaction system environments between funds accounts and virtual cards consistent with disclosed embodiments.

FIG. 9 is an illustrative diagram showing exemplary transactions between virtual cards consistent with disclosed embodiments.

FIG. 10 is a flowchart of an exemplary process for transferring funds between an originating account and a destination account, consistent with disclosed embodiments.

FIG. 11 is a flowchart of an exemplary process for assigning various user roles to participants of the digital system, consistent with disclosed embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms or definitions incorporated by reference.

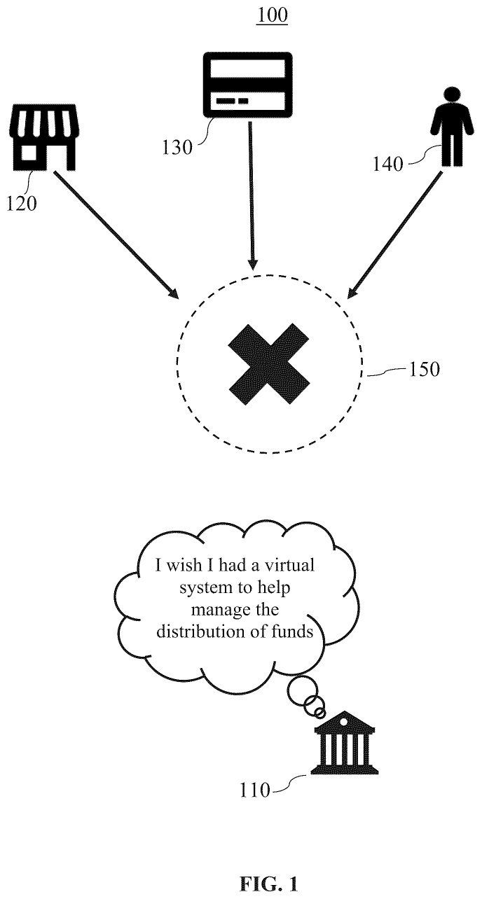

By way of example, FIG. 1 illustrates an exemplary problem 100 for managing the distribution of funds received, consistent with the disclosed embodiments. An organization 110 is shown, with a thought bubble that a member of organization 110 wants an improved virtual system to help manage the distribution of funds. Organization 110 may be a bank or other financial institution, a non-profit association, or some other business affiliation such as a university system that distributes funds. Third-parties 120 and physical cards 130 are also shown. Third-parties 120 may be certain services provided by another bank or other financial institution, or some additional services provided to transfer funds between two separate accounts. For example, such services may include Venmo, Zelle®, Cash App, PayPal, Google Pay™, or Payoneer®. Third-parties 120 may include any person that has no affiliation to organization 110. For example, third-parties 120 may be a parent, guardian, relative, friend, or other donor not affiliated with organization 110. Physical cards 130 represent antiquated methods of distributing funds that may include credit cards or debit cards. Participants 140 are also shown. Participants 140 may be persons associated with organization 110. Exemplary problem 100 shows third-parties 120, physical cards 130, and participants 140 all contributing to an account 150 with no system for allowing account 150 to know how much funds have been expensed from its various sources, i.e., third-parties 120, physical cards 130, and/or participants 140. Account 150 also has no seamless, two-way integration to allow funds to be distributed back to an original source account. Thus, a solution is needed to address the antiquated methods and systems for distributing funds and to address the problems associated with conventional solutions.

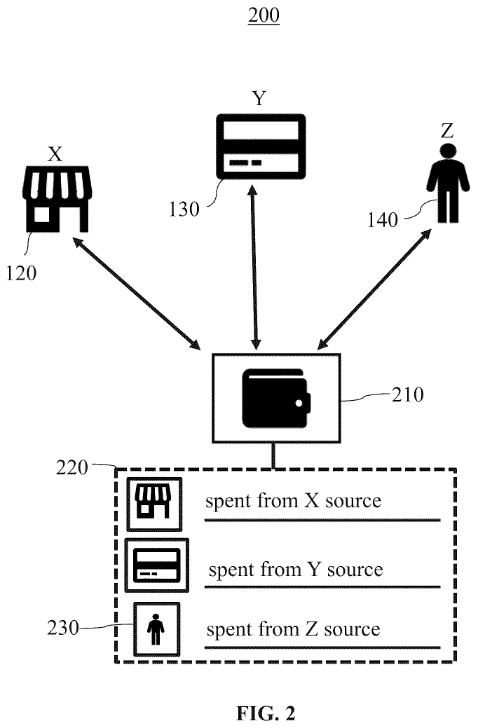

An object of the present invention may be to solve the deficiencies of current solutions. By way of example, FIG. 2 illustrates an exemplary solution 200 for managing the distribution of funds received, consistent with the disclosed embodiments. Organization 110 may provide a digital system where participants 140, as described with respect to FIG. 1, may be associated with a virtual card 210. To make the distribution of funds easier, virtual card 210 may receive funds from several different entities, including third-parties 120, physical cards 130, and/or participants 140. In some embodiments, participants 140 may provide funds to other participants 140's virtual card 210. The dual arrows between each of virtual card 210 and third-parties 120, physical cards 130, and participants 140, respectively, show exemplary solution 200 may include both sending and receiving funds directly between each of third-parties 120, physical cards 130, or participants 140 and virtual card 210. As part of the exemplary solution 200, virtual card 210 tracks total funds 220. Total funds 220 may include all funds available for use on virtual card 210, segmented into fund-source categories 230. As a participant 140 uses funds from her virtual card 210, total funds 220 may track and account for each transaction's fund source, totaling how much has been spent against each of fund-source categories 230. Thus, exemplary solution 200 presents a streamlined system through the use of a singular virtual card 210 that may track spending by individual source accounts. Likewise, exemplary solution 200 allow funds to be distributed back to an original source account.

Disclosed embodiments include a computer-implemented system for managing distribution of funds received. Computer implemented may refer to arrayed, assembled, furnished, supplied, carried out, or actions realized by a computer as specified by the software involved. Managing may refer to administering, overseeing, executing, or generally controlling the functions in any manner. Distribution may refer to handling, sharing, allocating, dispersing, allotting, apportioning, or generally giving out of an item intended for particular receipt. Funds received may refer to any currency, whether pecuniary or not, exchangeable and actually exchanged, accepted, collected, or earned that may be readily available. Non-limiting examples of managing the distribution of funds received may include marking identified funds from the originating party (i.e., the funder/donor), marking the identified funds destination party (i.e., the receiver/donee), and calculating changes in the distribution of funds. In some embodiments, system environment 300 may be managing the distribution of funds received for entities that exist within the same organization structure, such as an athletic department within a university administration system. In some embodiments, system environment 300 may handle managing the distribution of funds in an ecosystem where the entities comprise both participants 140, that are part of the organization 110, and other third parties, that are not part of the same organization 110. For example, managing the distribution of funds may include deposits from a university system and athletic department to a student athlete while also accommodating the deposits from a student athlete's parent.

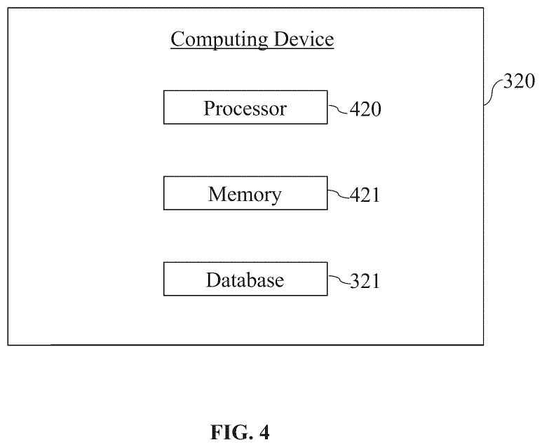

Disclosed embodiments include a memory storing a set of instructions. Memory may refer to devices that perform one or more operations consistent with the disclosed embodiments of the invention, and as further described with respect to FIG. 4. For example, system environment 300 may include memory devices storing data and software instructions and processors configured to use associated data and execute the software instructions to perform the functions and operations known to those skilled in the art. Storing may refer to intaking, loading, holding, containing, outputting, or to retain data in a memory unit. Set of instructions may refer to any technique, program, method, procedure, or other rules for the guidance, use, and functions of the memory unit. The memory storing a set of instructions are discussed more fully in other portions of this disclosure.

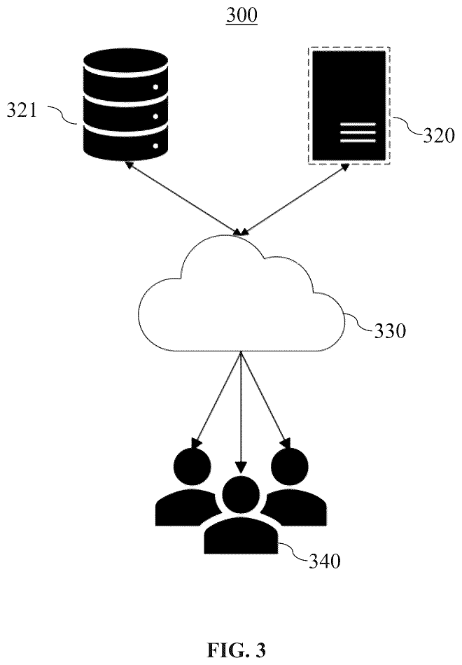

Disclosed embodiments include a database, in electronic communication with the memory, configured to store information. Database may refer to one or more memory devices that store information. Likewise, database may refer to computing components such as database management systems (DBMS) and database servers, themselves configured to acquire and process requests for data stored in memory devices of databases and to provide data from the database, as further described with respect to FIGS. 3 and 4. Further, the database may include, for example, data and information related to the source and destination of a network request, the data contained in the request, and so forth. Electronic communication may refer to any means of transfer of data, messaging, signals, or other process that exchanges information digitally. As a non-limiting example, the use of File Transfer Protocol (FTP) may be within the scope of the present invention. Store shall refer to the same meaning as the term storing as used throughout the present disclosure. Information may refer to input, output, storage, transmission, instructions, or other data at any stage of processing. Disclosed embodiments also include processors, which may refer to any logic circuitry that responds and processes instructions that drive a computer such as CPUs, GPUs, Multi-Core Processors, ASICs, and so forth.

By way of example, FIG. 3 is a block diagram of an exemplary system for managing distribution of funds received, consistent with disclosed embodiments. System environment 300 may include at least one network 330, one or more users 340, at least one computing device 320, and at least one database 321, as shown in FIG. 3.

The various components of system environment 300 may communicate over at least one network 330. Network 330 may comprise any computer networking arrangement used to exchange data. For example, such communications may take place across various types of networks such as the Internet, a wired Wide Area Network (WAN), a wired Local Area Network (LAN), a wireless WAN (e.g., WiMAX), a wireless LAN, such as Wi-Fi based on IEEE 802.11 standards, a mesh network, a mobile/cellular network, an enterprise or private data network, a storage area network, a virtual private network using a public network, a nearfield communications technique (e.g., Bluetooth, infrared, etc.), or various other types of network communications that enable the components of system environment 300 to send and acquire information. In some embodiments, the communications may take place across two or more of these forms of networks and protocols that can communicate between and amongst each other. While system environment 300 may show as a network-based environment, it is understood that in some embodiments, one or more aspects of the disclosed systems and methods may also be used in a localized system, with one or more of the components communicating directly with each other. If network 330 may be a local network that exchanges data in a localized area, then the local network operates in such a way to enable components of system environment 300 and other servers, computers, and systems of components of system environment 300 to interact with one another and to connect to network 330. In some embodiments, components of system environment 300 may communicate via network 330 without a separate local network. In addition, system environment 300 may further include other components that perform or assist in the performance of one or more processes that are consistent with the disclosed embodiments.

In some embodiments, system environment 300 for managing distribution of funds may include at least one database 321. Database 321 may include one or more memory devices that store information. For example, database 321 may be a relational database such as Oracle™ databases, or a non-relational database such as mongo and HBase™. The databases and other files may include, for example, data and information related to origin and destination of a network request and the data contained in the request therein. Additionally, database 321 may include computing components such as database management systems and database servers configured to acquire and process requests for data stored in memory devices of databases and to provide data from such databases. Database 321 may be included on a volatile or non-volatile, magnetic, semiconductor, tape, optical, removable, non-removable, or other type of storage device or tangible or non-transitory computer-readable medium. Database 321 may also be part of computing device 320 or separate from computing device 320. The manager of the organization which uses the present invention may use any suitable database for the needs of the organization. This ranges from small databases, hosted on a workstation, to large databases, distributed among several data centers.

In some embodiments, system environment 300 for managing distribution of funds may include one or more computing device 320. For example, computing device 320 may include memory configured to store one or more software programs that perform several functions when executed by a processor. Computing device 320 may include any form of remote computing device configured to receive, store, and transmit data. For example, computing device 320 may be a server configured to store files accessible through a network (e.g., a web server, application server, virtualized server, etc.). Other components known to one of ordinary skill in the art may be included in system environment 300 to gather, process, transmit, receive, acquire, and provide information used in conjunction with the disclosed embodiments. In addition, system environment 300 may further include other components that perform or assist in the performance of one or more processes that are consistent with the disclosed embodiments. Computing device 320 may interact with a database 321 to, for example, receive, store, and/or update information in database 321. Database 321 may not be part of computing device 320, and instead, computing device 320 may exchange data with database 321 via a communication link. A communication link may refer to any channel that connects two or more devices for the purpose of transmitting data. For example, a communication link may refer to a physical link or to logical links, such as point-to-point links, point-to-multipoint links, or broadcast links. Further, the communication link may refer to communication simplex, half-duplex, or full-duplex connections. Database 321 may include one or more memory devices that store data and instructions used to perform one or more features of the disclosed embodiments, as described with respect to FIG. 3. Database 321 may include any suitable databases, ranging from small databases managed on a working station to large databases distributed among data centers. Database 321 may also include any combination of one or more databases controlled by memory controller devices (e.g., server(s), etc.) or software. For example, database 321 may include document management systems, Microsoft SQL™ databases, SharePoint™ databases, Oracle™ databases, Sybase™ databases, other relational databases, or non-relational databases, such as mongo and others. Although FIG. 3 shows one database 321, system environment 300 may include one or more databases 321, which may be used to store various types of information associated with customers of a financial institution.

Users 340 in system environment 300 may include any entity that provides, manages, contributes toward, and/or maintains virtual card balances. Users 340 may include any personnel with access to system environment 300 and may be a currently registered member of the organization owning a corporate account such as participants 140. Users 340 may include organization 110 managing distribution of funds. Users 340 may also, or alternatively, include other third parties who are not affiliated with organization 110. Users 340 may access a virtual card balance stored in database 321 through a browser or other software deployed on computing device 320, and the virtual card balance may be updated by computing device 320. The update may occur automatically or after receiving an input by users 340. In some embodiments, users 340 may use any form of a computer-based device to access the virtual card balance. For example, users 340 may use a personal computer (e.g., a desktop or laptop computer), a mobile device (e.g., a mobile phone or tablet), a wearable device (e.g., a smart watch, smart jewelry, implantable device, fitness tracker, smart clothing, head mounted display, etc.), an IoT device (e.g., smart home devices, industrial devices, etc.), or any other device that may be capable of accessing web pages. In other embodiments, computing device 320 used by users 340 may be a virtual machine (e.g., based on AWS™, Azure™, IBM Cloud™, etc.), container instance (e.g., Docker™ container, Java™ container, Windows Server™ container, etc.), or other virtualized instance. Using the disclosed methods, the activity of users 340 through computing device 320 may be monitored and recorded by a browser extension executing on computing device 320.

FIG. 4 is a diagram showing an example computing device 320, consistent with disclosed embodiments. As described with respect to FIG. 3, computing device 320 may be at least one device configured to allow data to be received and/or transmitted by system environment 300 (e.g., a server, etc.) and may include one or more dedicated processors and/or memories. For example, computing device 320 may include a processor 420 (or multiple processors), and a memory 421 (or multiple memories), as shown in FIG. 4. Computing device 320 may include one or more digital and/or analog devices that allow computing device 320 to communicate with other machines and devices, such as other components of system environment 300. Computing device 320 may include one or more input/output devices. Computing device 320 may include a screen for displaying communications to users 340. In some embodiments, computing device 320 may include a touch screen. Computing device 320 may include other components known in the art for interacting with a user. Computing device 320 may also include one or more digital and/or analog devices that allow a user to interact with system environment 300, such as touch-sensitive area, keyboard, buttons, or microphones.

Processor 420 may take the form of, but may not be limited to, one or more integrated circuits (IC), including application-specific integrated circuits (ASICs), microchips, microcontrollers, microprocessors, embedded processor, all or part of a central processing unit (CPU), graphics processing unit (GPU), digital signal processor (DSP), field-programmable gate array (FPGA), server, virtual server, system on an chip (SOC) or other circuits suitable for executing instructions or performing logic operations. Processor 420 may also be based on the Advanced RISC Machines (ARM) architecture, a mobile processor, or a graphics processing unit, etc.

Memory 421 may include one or more storage devices configured to store instructions used by processor 420 to perform functions related to computing device 320. The disclosed embodiments are not limited to software programs or devices configured to perform dedicated tasks. For example, memory 421 may store a single program, such as a user-level application, which performs the functions associated with the disclosed embodiments, or may comprise multiple software programs. Additionally, processor 420 may, in some embodiments, execute one or more programs (or portions thereof) remotely located from computing device 320. Furthermore, memory 421 may include one or more storage devices configured to store data for use by the programs. Memory 421 may include, but may not be limited to a hard drive, a solid-state drive, a CD-ROM drive, a peripheral storage device (e.g., an external hard drive, a USB drive, etc.), a network drive, a cloud storage device, or any other storage device.

Computing device 320 may also include database 321, as described with respect to FIG. 3. Database 321 may also be part of computing device 320 or may be separate from computing device 320. In some embodiments, computing device 320 may include one or more input/output devices, communications devices, displays, and/or other interfaces (e.g., server-to-server, database to-to-database, or other network connections).

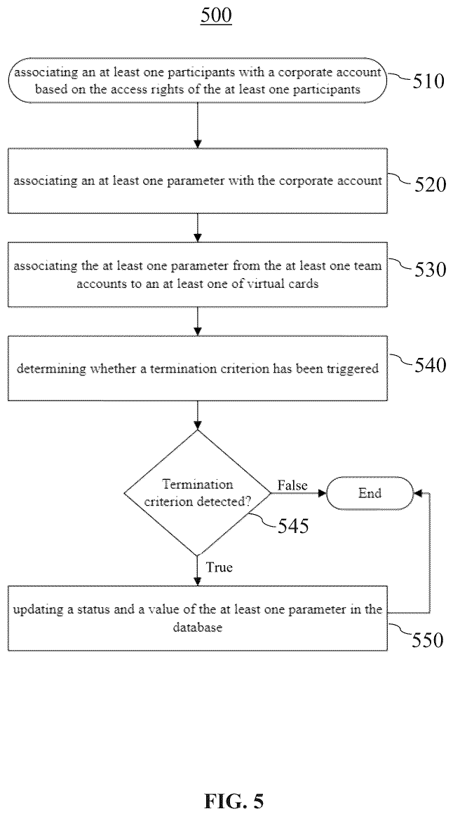

By way of example, FIG. 5 is a flowchart of an exemplary process for managing the distribution of funds received, consistent with disclosed embodiments. Process 500 may be performed by at least one processing device of a computing device, such as processor 420, as described with respect to FIG. 4. In some embodiments, a non-transitory computer-readable medium may contain instructions that when executed by a processor cause the processor to perform process 500. Further, process 500 is not necessarily limited to the steps shown in FIG. 5.

In step 510, process 500 may include associating at least one participants with a corporate account. Associating at least one participants may refer to comparing, verifying, ensuring, confirming, matching, or otherwise connecting participants, such as participants 110, to a corporate account, such as an account associated with an organization, such as organization 105. In some embodiments, the associating may include associating the at least one participants based on the access rights of the at least one participants, wherein the at least one participants may be a currently registered member of the organization that owns the corporate account. Corporate account information may refer to information derived from the global entity that oversees and manages the distribution of funds received. For example, a corporate account may refer to that of a university system that oversees and manages the distribution of funds to its various departments.

Access rights may refer to any manner in which participants show appropriate credentialling that connects participants to the organization that owns the corporate account. The organization that owns the corporate account may refer to any organization that uses the system and methods described herein. Associating participants based on access rights may include any means to authenticate a participant's identity to show proof of connection to an organization. For example, means of authentication may include token authentication, multi-factor authentication, password-based authentication, biometric-based authentication, facial recognition, or other similar authentication techniques. The use of credentials may be derived from a programmatic interface, such as a user login interface. For example, participants may have basic username and password credentials. The use of credentials may be derived programmatically by making calls to an application program interface (API). Making calls to an API may refer broadly to any request, response, message, or exchange of data between two or more computer systems, such as between client and server, or any combination of backend, middleware, and frontend components. Examples of making calls to an API include calls related to read functions, write functions, delete functions, get/fetch functions, post functions, update functions, upload functions, download functions, functions to add or remove objects, start instances, stop or terminate instances, authentication functions, custom functions, or any other function that can be reasonably performed by an API call. For example, participants'web service may use API keys and tokens where a particular API key generates upon the first instance of using the system environment and associates to a particular token for all future credentialling. Currently registered member may refer to any participants who have an association with an organization that owns the corporate account. For example, the determination of a currently registered member may occur through a domain name, by email extension, by unique key identifier, or by reference to a separate look-up array to show participants as associated with an organization. The determination of a currently registered member may occur when any participant uses their virtual card or when any participant logs in to an appropriate web browser portal, intranet portal, or mobile application that allows participants to enter an amount of funds to be distributed to one or more team accounts. As a non-limiting example, a student athlete may provide login credentials that includes a student email address. Process 500 may then use the student email address to confirm the student may be enrolled in the system environment, such as using a certain university domain. In some embodiments, confirmation may occur by matching the student email address against a database, such as database 321, to confirm that the student may be eligible for participation. In some embodiments, process 500 may proceed to step 520.

In step 520, process 500 may include associating at least one parameter with the corporate account, wherein the at least one parameter updates at least one team accounts, wherein the updates to the at least one team accounts may be updated in a database. Parameter may refer to any value, constraint, data, point, entry, element, characteristic, or other variable that may be stored in a database, such as database 321. Updates may refer to implementing, causing, or facilitating any revision, adjustment, modification, deletion, addition, substitution, correction, or further refinement to the team accounts as well as the database. Associating at least one parameter with the corporate account may refer to any connection of participant information to the corporate account. As a non-limiting example, the system may associate a participant to the corporate account based on the email domain address to verify the domain address belongs to the organization that owns the corporate account. Updating the at least one team accounts using the parameter may refer to any change to the parameter. For example, the distribution of funds from a corporate account to a team account may involve the update of the amount of funds distributed to the team account. Team accounts may refer to secondary or intermediary accounts that fall under the supervision, instruction, rules, or other guidance of a corporate account. As a non-limiting example, the various departments under a university system may be team accounts. As further illustration, a university's athletic department may comprise a single team account. Team account information may refer to any information that describes a team account. For example, information such as the name of the team, participants that oversee or manage the team account, and the amount of funds distributed to the team account may be incorporated as team account information. In some embodiments, there may be several levels of team accounts. In some embodiments, team accounts may be managed by a bank or a virtual card provider. A team account may be used by an organization for budgeting purposes. In some embodiments, the funds distributed to each team account may be the same. In some embodiments, each team account may receive a different distribution of funds. For example, some embodiments may include a university corporate account that distributes funds to a single university athletic department, wherein the athletic department further manages the distribution of funds to several individual athletic program team accounts. The invention operates in the same manner regardless of how many levels of team accounts the organization that owns the corporate account uses.

In step 530, process 500 may include associating the at least one parameter from the at least one team accounts to at least one virtual cards, wherein the at least one parameter to the at least one virtual cards may be associated with the at least one participants and the database may be updated based on the associating. Participant information may refer to any information that describes any participants, such as participants 140. As a non-limiting example, the management of the distribution of funds received between a university system and an individual student athlete may include the distribution of funds for the student athlete that includes such funds for athlete allowances, travel per diems, payments on a student athlete's individual name, image, and likeness (NIL) and so forth. In some embodiments, the present invention may include the distribution of funds received from some entity that may not be affiliated with the same team account. For example, a student athlete may receive the distribution of funds received from a separate university system department entity such as financial aid, or an individual department's payments to the student for work-performed for on-campus jobs. In some embodiments, the distribution of funds to a student athlete may come from parties that may not be affiliated with the same corporate account. As a non-limiting example, a student athlete may receive funding through a parent, guardian, relative, friend, or other donor not affiliated with the university system.

Virtual cards may refer to any form of a wallet application that involves a contactless card capable of contactless payment, as understood by those skilled in the relevant art. For example, such virtual cards may include a digital wallet that may store participants'payment and credentialling information that may be accessible from a computer. In some embodiments, virtual cards may be stored on any mobile device compatible for point-of-sale (POS) transactions, as discussed more fully in other portions of this disclosure. As a non-limiting example, an organization may have certain participants that oversee a team account and manage distribution of funds to at least one virtual cards. In some embodiments, virtual cards may be incorporated into other digital wallet applications managed by outside financial institutions. For example, participants may hold a bank account with a debit card in addition to a virtual card, wherein the participant's debit card and virtual card accounts may be separate accounts that may both be managed by a single financial institution. Updating the database based on the associating of the at least one participants to the at least one virtual cards may include any change to a status or a value of account balance information.

Account balance information may refer to any information related to the funds received by a unique participant's virtual card, such as the amount of funds initially received, the team account information from where the funds are received, the time of the transaction, the date of the transaction, and the policies, limits, or rules associated with the distribution of the funds received, if any. For example, the updating may occur based on a determination that a certain amount of funds should be distributed to a specific virtual card. The parameter associated with a dollar amount for the specific virtual card may be updated in the database based on that determination. In some embodiments, a virtual card may be associated with only one participant. For example, a student athlete may be assigned a unique virtual card for the use of athletic expenses and per diems calculated for that student athlete's individual needs. In some embodiments, a virtual card may be associated with more than one participant. For example, a student organization may receive a certain distribution of funds received by a university student organization team account. The student organization may have several members, each of which have an association to the student organization virtual card account balance that each of the several members may expense against. The several members may each have unique virtual cards that expense against the account balance or share one card to use against the account balance.

In some embodiments, certain per diems may be calculated for a virtual card that may be based on individual transactional limits. For example, a university system may assign a per diem policy to a student athlete given a virtual card, consistent with the disclosures herein. For example, a per diem policy may be set on a per meal basis such that a student athlete may get a specific amount of funds per meal, i.e., breakfast, lunch, dinner, and snacks, respectively. In some embodiments, a per diem policy may be associated with a time period. For example, a participant may have a daily, weekly, or by-trip limit for a specific amount of funds that may be expensed against a participant's virtual card during the time period. In some embodiments, if a participant attempts to spend more than the per diem policy limit for a given meal and/or for a given time period, then the transaction may still process as long as funds remain on a virtual card. In other embodiments, if a participant attempts to spend more than an allocated per diem policy limit for a given meal, the transaction may be blocked. In other embodiments, if a participant attempts to spend more than an allocated amount for a given meal, process 500 may only use such amount of funds as apportioned before expending any remaining amount from a source separate from a virtual card. The system may determine which action to take based on configurations established by an organization using the system. For example, if a student attempts to spend more than his or her per diem limit for a certain meal, then a transaction may process with any difference between a total cost of a certain meal and a per diem limit of a certain meal being deducted from a student's associated funds account. A student's associated funds account may be any account that receives a distribution of funds that is separate from a virtual card. For example, associated funds accounts may include personal checking or savings accounts. A participant may associate his or her funds account with his or her virtual card. A participant may then be prompted by the system where an individual transaction would go beyond a per diem limit for a certain meal and/or a certain time period. The participant may then decide whether to continue with the transaction, wherein the system can deduct the difference between a total cost of a certain meal and a per diem limit of a certain meal from the participant's associated funds account. The participant may also decide to cancel the transaction to avoid overdrafting his or her virtual card.

In some embodiments, account balance information may be accessible and displayed to the at least one participants using a computerized device. The accessibility of the account balance information may refer to an ability of users, such as users 340, to access relevant information through a computerized device. Displaying the account balance information may refer to demonstrating, disclosing, showing, exhibiting, or otherwise publishing as an output of the account balance information on a screened device. For example, participants may want to know, at any time, the amount of available funds on their respective virtual cards. Participants, thus, may have a mobile application that links their respective virtual card to their account information shown from their computerized device. A computerized device may refer to any apparatus, appliance, machine, or other gadget controlled by a computer. As non-limiting examples, a computerized device may include personal computers, mobile devices, wearable devices, or Internet of Things (IoT) devices.

In some embodiments, the database, such as database 321, may update account balance information automatically or based on an input received in response to a prompt to the at least one participants. The account balance information may automatically update based on configurations set by organizational preferences. The organizational preferences may be in the form of designated SQL statements for updating information in the database. The organizational preferences may include batch-updating in real time, at set intervals, or at the call of an organization. For example, after a participant uses their virtual card to expend a portion of funds received, a database may update the available balance remaining that the participant may expend. In some embodiments, because of the complexity and volume of transactions that may be tracked, an organizational preference may update a database only once per day as a means of limiting expending computing operations on constant database updates. An input received in response to a prompt may refer to collecting, receiving, or in any way recognizing a choice, selection, status, state, or other similar entry indicative of any participants entry of at least one parameter.

As a non-limiting example, participants with credentials to the corporate account may log in to an appropriate web browser portal, intranet portal, or mobile application that allows participants to enter an amount of funds received to be distributed to one or more team accounts. The received input may connect the web browser portal, intranet portal, or mobile application to a network, such as network 330, that communicates with and sends the received input to a computing device, such as computing device 320, and a database, such as database 321. The input received in response to a prompt may occur via an accessibility GUI on a participant's web browser portal, intranet portal, or mobile application and may include any type of data inputted by a user using an input device, such as a keyboard, mouse click, touch pad, touch screen, joystick, microphone, and/or any other computer-connected device. In some examples, the received input may be in the form of at least one of: string text, Boolean value, character text, date, time, numeric, integer, or other similar data types.

In step 540, process 500 may include determining whether a termination criterion may be triggered, wherein the termination criterion may be predetermined by the system. Termination criterion may refer to at least one basis, measure, binary output, rule, or other standard of testing has been met or satisfied. The termination criterion may include particular calendar dates and times or the status of participants within the organization that owns the corporate account. For example, process 500 may be used in a university system, wherein a student athlete may originally attend the university system and be issued a virtual card under the appropriate team account before deciding to transfer schools outside of the university system. In some embodiments, process 500 may determine the student athlete's departure from the university system as triggering a termination criterion. Determining whether a termination criterion may be triggered may refer to process 500 evaluating whether the funds received and issued to certain virtual cards should be returned to the original source team accounts and/or corporate account. In some embodiments, the termination criterion may be predetermined. Predetermined termination criterion may refer to any such settings loaded by either an organization or participants. The settings may be calibrated at any time such that participants with the requisite credentials may update the settings to fit the needs or wants of the organization operating the corporate account and/or team accounts. For example, a university system may assign annual graduation dates as predetermined termination criterion for those students that graduate in the same year.

In some embodiments, participants with appropriate access controls may update any individual participant's status within the digital system, which may later cause the trigger of a termination criteria. Access controls may refer to a level of credentials within the system that provide for a certain number of accessible inputs and views for account information with the system. The system may provide for any number of levels of access controls, where the higher the level of access controls, the more control over the system is granted. For example, in process 500, an organization using the technology described herein may want to temporarily suspend users of certain virtual cards, and if some condition fails to occur for reactivation, then the organization using the digital system at step 540 may determine a termination criterion is met. As a non-limiting example, a university system may provide a participant with certain access controls to deactivate an existing virtual card of a student athlete who takes a leave of absence or studies abroad. The digital system may temporarily deactivate the virtual card, with an additional termination criterion triggered if the virtual card is not reactivated within some certain time frame after deactivation. Reactivation may be determined programmatically or as predetermined criteria. An organization may provide reactivation criteria that can be set programmatically. For example, an organization may determine that all virtual cards that are deactivated may be reactivated by using the deactivated card on the premises of the organization such that an on-premises transaction will reactive a deactivated virtual card. In some embodiments, the organization may provide predetermined criteria. For example, the organization may provide a time period where a virtual card, marked as deactivated, will remain deactivated. Upon completion of the time period, the system recognizes the time period has ended and the virtual card may be reactivated for use. A participant's status and a participant's access controls are discussed more fully in other portions of this disclosure.

In step 545, process 500 may include the output of the termination criterion detection. If the output is true, process 500 may move to step 550. For example, if a university system assigns annual graduation dates as termination criterion and a student graduates in the same year, step 545 may determine the output of the termination criterion to be true. Alternatively, if the output is false, process 500 may end without moving to step 550.

In step 550, process 500 may include updating a status of the at least one parameter in the database after determining a termination criterion may be met. The status may refer to the credentials of participants in the system environment. As non-limiting examples, the status may be active or inactive. An active status may refer to a live, running, or otherwise marked by a present operation status. For example, participants may have a status set as active if participants may be a member of the organization that uses the system environment. An inactive status may refer to a suspended or otherwise inoperative status. The status may also be set as inactive if participants have left the organization that uses the system environment. In some embodiments, process 500 may determine a set of statuses programmed based on the organization and needs of the organization. For example, a university system may provide additional statuses such as ‘injured’ or ‘ineligible’ to reflect unique statuses of student athletes with virtual cards.

In step 550, process 500 may include updating a value of the at least one parameter in the database after determining a termination criterion may be met. The value may refer to data and information about the at least one parameter. As non-limiting examples, the value may refer to the amount of funds transferred to the at least one team accounts, the account number for where the funds originated, the account number for where the funds distributed, or the time of the distribution. For example, the updating may occur based on a determination that a certain amount of funds should be distributed to a specific team account. The parameter associated with a dollar amount for the specific team may be updated in the database based on that determination. Updating the status and the value may refer to changing or eliminating participants' association with the corporate account and/or team accounts, the date of the termination criterion determination, or the account balance information of the funds received for the virtual card on which participants may be so related. In some embodiments, process 500 may include providing available funds to participants after the termination criterion has been met. For example, an issue of certain funds gifted to a student athlete may exist on the card for the student athlete's use notwithstanding the student athlete's graduation from the university system that owns the corporate account for which the virtual card may be associated. The use of the funds may require the student to transfer the funds to an alternative payment method, such as a mobile contactless credit card. For example, the funds may link to an account with a mobile contactless credit card, where the student may initiate a funds transfer request via web browser portal or mobile application. The funds transfer request may function through one or more of user input requests on mobile applications, or person-to-person contactless send-receipt requests.

In some embodiments, process 500 may prevent providing funds to participants after the termination criterion has been met. For example, a semesterly travel per diem allotted for a student athlete that goes partially unused may be rolled back into the team account for use in future semester travel expenses. The information associated with updating the status and value of the at least one parameter may refer to any data stored in a database. As non-limiting examples, such information may include the amount of funds received transferred to the at least one virtual cards, the amount of funds received transferred to the at least one team accounts, the account number for where the funds received originated, the account number for where the funds received distributed, and the time of the distribution.

In some embodiments, process 500 may use a termination criterion that triggers collection from at least one virtual cards associated with at least two team accounts. In some embodiments, process 500 may include the collection of funds includes determining an original distribution of funds received to the at least one virtual cards from each of the at least two team accounts. An original distribution of funds received may refer to the initial distribution of funds provided by each of the at least two team accounts associated with the one virtual card.

Alternatively, an original distribution of funds received may refer to the total amount of distributions of funds provided by each of the at least two team accounts provided the one virtual card between the time period participants were first issued a virtual card to the time of any termination criterion being met.

In some embodiments, process 500 may further include determining a remaining balance of funds received to the at least one virtual cards from each of the at least two team accounts. A remaining balance of funds received may refer to the amount of funds expensed since the initial distribution of funds provided by each of the at least two team accounts associated with the one virtual card. Alternatively, a remaining distribution of funds received may refer to the total amount of expenses attributed to funds provided by each of the at least two team accounts provided the one virtual card between the time period participants were first issued a virtual card to the time of any termination criterion being met. Participants may have access to retroactively attribute such expenses to any team account. For example, a participant may use an online web browser portal with their associated credentials to see their account expenses. Within the web browser portal, participants may then delineate each expense and assign a team account the funds received should be associated to. Alternatively, process 500 may automatically account for the expenses based on the type of transaction incurred and the associated team account rules or limits. For example, a student athlete may have a virtual card that has been assigned funds from both a university athletics department as well as a student department from an on-campus job. If the student athlete expends funds on food and dining, that may automatically be associated with the student athlete's funds received from his or her on-campus job. However, if the student athlete expends funds on traveling to an away game for his or her sport, that may automatically be associated with the student athlete's funds received from the university athletics department.

In some embodiments, process 500 may use termination criterion that results in collecting the remaining balance of funds from the at least one virtual cards. Collecting the remaining balance of funds may refer to aggregating or accumulating the sums of funds. In some embodiments, the collection of the remaining balance of funds in process 500 may include distributing the remaining funds for each of the at least two team accounts based on the difference between the original distribution of funds and the remaining balance of funds to each of the at least two team accounts. The difference between the original distribution of funds and the remaining balance of funds may include subtraction or other similar mathematical operation. Distributing the remaining funds may refer to providing the difference between the original distribution of funds provided by each of the at least two team accounts associated with the one virtual card and the amount of funds expensed. Alternatively, the remaining funds may refer to the total amount of distributions of funds provided by each of the at least two team accounts provided the one virtual card between the time period participants were first issued a virtual card to the time of any termination criterion being met and the total expenses attributed to each of the at least two team accounts provided to the one virtual card during the same time period as described above. In some embodiments, the distribution of the remaining funds received in process 500 may be based on a policy. A policy may refer to a rule, scheme, protocol, or other procedure authorized for how the organization will distribute the funds to two or more team accounts. As a non-limiting example, the organization that owns the corporate account may institute a policy that requires all funds be earmarked prior to distributing the remaining funds. In some embodiments, any unmarked funds may not be allowed to be used in calculating the difference of funds expensed, and subsequent calculation or later verification may occur in order to gain the proper amount of funds expensed. For example, process 500 may ignore any unmarked funds when it determines the amount of funds that should collect to the respective team accounts. In such example, process 500 may require later manual intervention to modify the collection amounts determined by process 500. The organization that owns the corporate account may instead dictate that all funds remaining at the time of the termination criterion being met are rolled up through the team accounts back into the corporate account. This process may simplify the collection and distribution of the funds received and provide less risk of error or need for administerial oversight.

It is to be understood that in some embodiments, the steps of the corresponding process are not necessarily performed according to the sequence shown in FIG. 5 and described in the present disclosure. In some other embodiments, process 500 may include more or fewer steps than those described in the present disclosure. In addition, a single step described in the present disclosure may be divided into a plurality of steps for description in other embodiments; and a plurality of steps described in the present disclosure may also be combined into a single step for description in other embodiments.

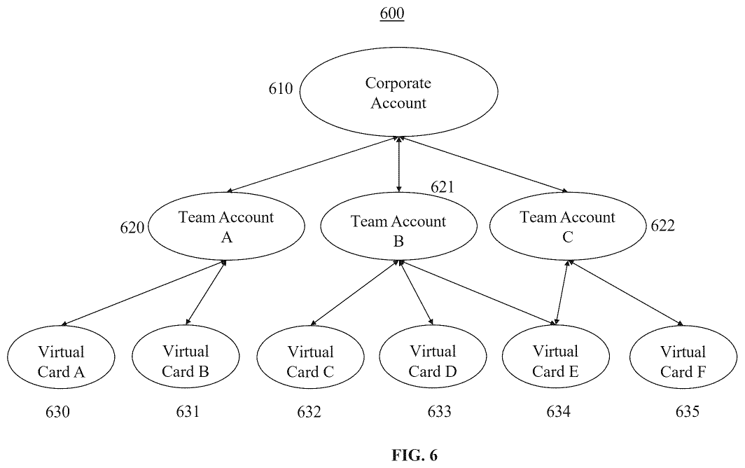

By way of further example, FIG. 6 is a diagram of the topological structure for the environment and account associations for the distribution of funds received, consistent with disclosed embodiments. Structure 600 may comprise three levels of accounts: a corporate account (e.g., corporate account 610), at least one team accounts (e.g., team account A 620, team account B 621, and team account C 622), and at least one virtual cards (e.g., virtual card A 630, virtual card B 631, virtual card C 632, virtual card D 633, virtual card E 634, and virtual card F 635). Each component in structure 600 may represent a different account or virtual card. Corporate account 610 may be owned by an organization, such as organization 105, and may be managed by a bank. In some embodiments, the entire structure 600 may have one corporate account. In other embodiments, structure 600 may have a plurality of corporate accounts, with each account owned by a different organization or with multiple corporate accounts owned by the same organization. A team account may only be associated with one corporate account, such as corporate account 610. As depicted in FIG. 6, team account A 620, team account B 621, and team account C 622 may only be associated with corporate account 610.

A virtual card may have two levels of association. In some embodiments, a virtual card may only be associated with one team account and one corporate account, as shown with exemplary virtual card A 630 and virtual card B 631. In other embodiments, a virtual card may be associated with multiple team accounts and one corporate account, as shown with exemplary virtual card E 634.

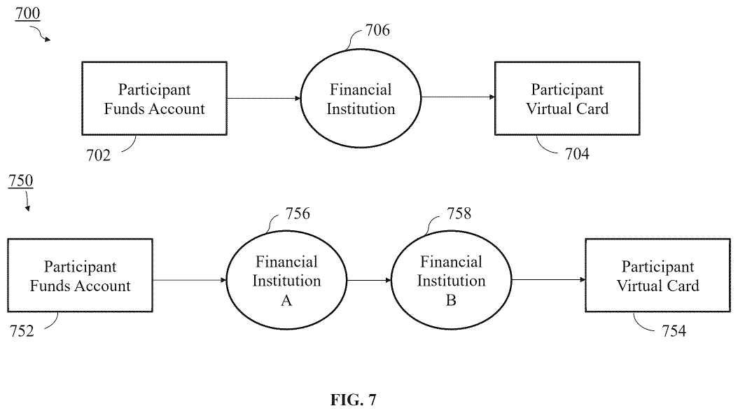

FIG. 7 is an illustrative diagram for exemplary transactions 700 and 750 for transferring funds to a participant virtual card, consistent with disclosed embodiments. At exemplary transaction 700, a participant may transfer funds through a financial institution without needing to resort to using physical cards third-party services for completing transactions. In some embodiments, at exemplary transaction 700, a participant is associated with financial institution 706 by holding an associated participant funds account 702. Participant funds account 702 may be any form of a traditional checking and/or savings account that a participant holds at financial institution 706. Financial institution 706 may be any entity that facilities the exchange or transaction of money. For example, financial institution 706 may be a bank, credit union, mortgage lender, insurance company, or brokerage firm. Participant virtual card 704 may be any form of a wallet application that involves a contactless card capable of contactless payment, held at financial institution 706. In exemplary transaction 700, financial institution 706 may receive or retrieve an amount of funds from participant funds account 702 after a participant requests that a certain amount of funds be transferred into participant virtual card 704. Financial institution 706 may receive or retrieve an amount of funds by a mobile application or web browser request. The request may verify that sufficient funds exist to withdraw from the participant funds account 702 before completing the transfer. If financial institution 706 cannot verify sufficient funds exist, then the exemplary transaction 700 may be cancelled to avoid any overdrafting. Financial institution 706 may then send or deposit the received amount of funds into participant virtual card 704.

Exemplary transaction 750 illustrates a transaction where a participant may transfer funds through at least two financial institution without needing to resort to using physical cards or third-party services for completing transactions. In exemplary transaction 750, a participant holds a funds account at financial institution A 756 and a virtual card at financial institution B 758, where financial institution A 756 and financial institution B 758 are separate respective financial institutions. In some embodiments, during exemplary transaction 750, a participant may be associated with financial institution A 756 by holding an associated participant funds account 752. Participant funds account 752 may be any form of a traditional checking and/or savings account that a participant holds at financial institution A 756. Financial institution A 756 may be any entity that facilities the exchange or transaction of money. For example, financial institution A 756 may be a bank, credit union, mortgage lender, insurance company, or brokerage firm. In exemplary transaction 750, financial institution A 756 may receive or retrieve an amount of funds from participant funds account 752 after a participant requests that a certain amount of funds be transferred into participant virtual card 754. Thereafter, financial institution A 756 may cooperate with a separate financial institution B 758. For example, cooperating with financial institution B 758 may include using conventional inter-financial institution transfer systems that readily transfer funds between distinct institutions. Inter-financial institution transfer system may be any form of electronic funds transfer protocols for sending and receiving funds between different financial institutions, such as SWIFT, CHIPS, or Automated Clearing House (ACH). Financial institution B 758 may then send or deposit the received amount of funds into participant virtual card 754. Financial institution B 758 may be any person that facilities the exchange or transaction of money, separate and distinct from financial institution A 756. Participant's virtual card 754 may be any form of a wallet application that involves a contactless card capable of contactless payment, held at financial institution B 758. While exemplary transactions 700 and 750 are limited to showing one and two financial institution systems, respectively, it is understood that these figures are merely exemplary and not limiting.

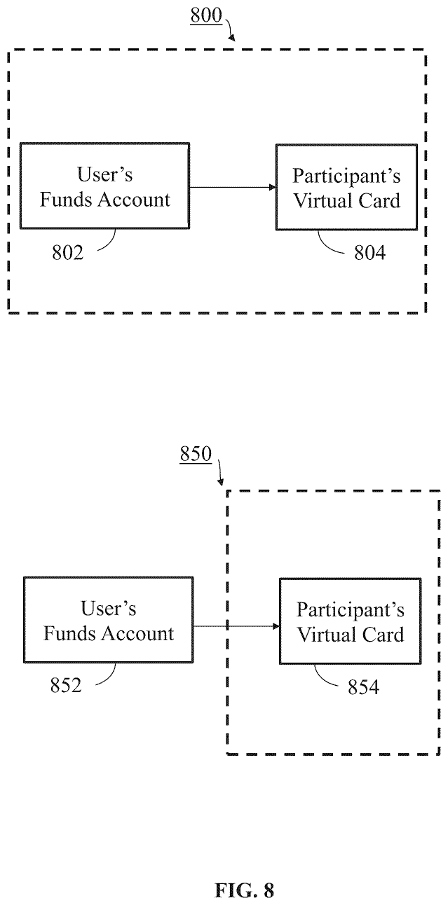

The technology disclosed herein also contemplates receiving a distribution of funds from users, who may or may not be part of the organization implementing the digital system. FIG. 8 is an illustrative diagram of exemplary transactions 800 and 850 for transferring funds to a participant virtual card, consistent with disclosed embodiments. At exemplary transaction 800, a user may transfer funds to a participant's virtual card without needing to resort to using physical cards or third-party services for completing transactions. A user, as previously defined herein, may be any personnel with access to the system that may be affiliated with the organization (i.e., participants). For example, a first participant may send funds from its own funds account to a second participant's virtual card. A user may also be any personnel with access to the system, but who is not affiliated with the organization (i.e., third parties) that may contribute to the balance of a virtual card. For example, a university system may allow for a parent or guardian to contribute funds to a student's virtual card balance despite the parent or guardian not being a member of the university system. Exemplary transaction 800 may represent a system environment where a user may send funds from a funds account 802 to a participant's virtual card 804. User's funds accounts 802 may refer to any form of a traditional checking and/or savings account that a user holds at a financial institution. Participant's virtual card 804 may be any form of a wallet application that involves a contactless card capable of contactless payment, held at the same financial institution as a user's funds account 802. A financial institution may receive or retrieve an amount of funds from a user's funds account 802 after a participant requests that a certain amount of funds be transferred into a participant's virtual card 804. The financial institution may then confirm sufficient funds exist in a user's funds account 802, and after confirmation, send or deposit the received amount of funds into a participant's virtual card 804. For example, a parent may hold a funds account at the same financial institution where a student's university provides virtual cards such that the parent may send funds to the student's virtual card through a mobile application or web browser. The parent may initiate a certain withdrawal from her financial institution's mobile application for the certain amount to be deposited in her student's virtual card. The mobile application may receive the request, verifying sufficient funds exist to withdraw from the parent's funds account before completing the transfer. If the financial institution cannot verify sufficient funds exist, then exemplary transaction 800 may be cancelled to avoid any overdrafting.

Exemplary transaction 850 represents a system environment where a user may hold a funds account 852 at a separate financial institution than the financial institution that may support the organization's virtual cards 854. User's funds accounts 852 may refer to any form of a traditional checking and/or savings account that a user holds at a financial institution. Participant's virtual card 854 may be any form of a wallet application that involves a contactless card capable of contactless payment, held at some financial institution separate and distinct from where user's funds account 852 is held. A financial institution may receive or retrieve an amount of funds from a user's funds account 852 after a participant requests that a certain amount of funds be transferred into a participant's virtual card 854. The financial institution may then confirm sufficient funds exist in a user's funds account 852, and after confirmation, send the received amount of funds to the separate financial institution for depositing into a participant's virtual card 854. The transfer of funds in exemplary transaction 850 may take place in the same manner as described more fully above with respect to exemplary transaction 750 in FIG. 7.

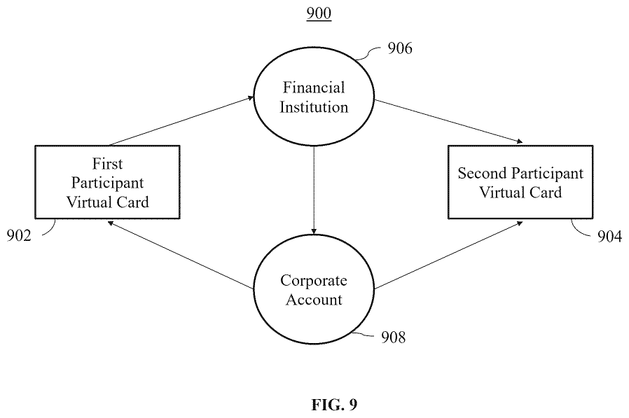

In some embodiments, a first participant may want to send a portion of funds from its virtual card to a second participant without needing to exchange cash or resort to seeking third-party financial transfer services. FIG. 9 is an illustrative diagram of an exemplary transaction 900 that facilitates the transfer of funds from a first participant virtual card 902 to a second participant virtual card 904, consistent with disclosed embodiments. First participant virtual card 902 and second participant virtual card 904 may be any form of a wallet application that involves a contactless card capable of contactless payment. Financial institution 906 may be any entity that facilities the exchange or transaction of money. In exemplary transaction 900, a financial institution 906 may provide a certain amount of funds to an organization that owns corporate account 908. Corporate account 908 may refer to any organization's account using the system for distributing funds described herein. Corporate account 908 may distribute funds to virtual cards including first participant card 902 and second participant virtual card 904. At some point, a first participant may want to transfer a certain amount of funds from her virtual card, i.e., first participant virtual card 902 to a second participant's virtual card, i.e., second participant virtual card 904. In some embodiments, this transaction may be initiated by a first participant using a computerized device. A transaction may include source account information, such as a first participant virtual card 902 information, and the destination account information, such as a second participant virtual card 904 information. After a first participant provides the amount of funds to be transferred to a second participant, the transaction may be sent through a financial institution 906. Financial institution 906 receive or retrieve an amount of funds from first participant virtual card 902 after a first participant requests that a certain amount of funds be transferred into a second participant virtual card 904.

Financial institution 906 may then send or deposit the received amount of funds into a second participant virtual card 904. In some embodiments, not depicted in FIG. 9, an exemplary transaction 900 may take place between virtual cards where two participants hold virtual cards at different financial institutions. In some embodiments, also not depicted in FIG. 9, an exemplary transaction 900 may take place between a first participant's first virtual card and a first participant's second virtual card. A participant may be part of two different teams in an organization using the system described herein, each team providing a virtual card with certain funds for use. A participant may choose to send certain funds from her first virtual card to her second virtual card. As a non-limiting example, a student at a university using the system described herein may have two virtual cards: one virtual card representing funds for general expenses and a second virtual card representing funds for a student meal plan. The student may transfer certain funds from her first virtual card for general expenses to her second virtual card for use on university meals.

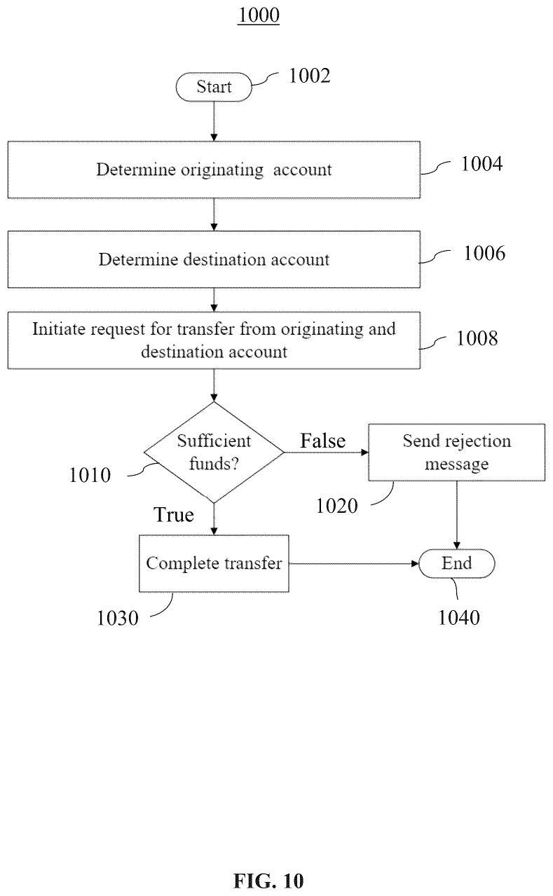

FIG. 10 is a flowchart of an exemplary process for transferring funds between an originating account and a destination account, consistent with disclosed embodiments. At step 1002, process 1000 may start. Process 1000 may start where a user enters a mobile application or web browser configured to enter account information for the transmission of funds.

At step 1004, process 1000 may determine an originating account. Determining an originating account may refer to capturing originating account information about any account in which funds will be withdrawn from. An originating account may include a participant's funds account or virtual card, a user's funds account, or a corporate account. For example, for a university system, such accounts may be personal accounts of parents or guardians held at financial institutions, personal accounts of students held at financial institutions, or funds from the university system's various accounts. Capturing originating account information may include recording details about the name of the originating account holder, the name of the financial institution that holds the originating account, the date and time of the transaction, and the amount of funds requested to be withdrawn.

At step 1006, process 1000 may determine a destination account. Determining a destination account may refer to capturing destination account information about any account in which funds may be deposited into. A destination account may include and cover the same accounts as described above for an originating account. Capturing destination account information may include recording details about the name of the destination account holder, the name of the financial institution that holds the destination account, the date and time of the transaction, and the amount of funds requested to be deposited.

At step 1008, process 1000 may initiate a request for transfer from an originating account to a destination account. Initiating a request for transfer may include having a processer identify and call an originating account and identify a destination account. Process 1000 may identify the captured originating account information and the captured destination account information for mapping a call request. When the processor makes a call requesting a withdrawal from an originating account, process 1000 may establish a connection between an originating account and a destination account. As a non-limiting example, a connection may include an application programming interface (API) that is created and called by the originating account's financial institution.

In some embodiments, process 1000 may proceed to interim step 1010. At interim step 1010, process 1000 may determine there are sufficient funds in the originating account to fund the destination account. In some embodiments, interim step 1010 may occur to ensure a request does not result in a negative account balance in the originating account. At step 1010, process 1000 may determine whether the originating account has sufficient funds. Determining whether an originating account has sufficient funds may refer to performing a mathematical operation prior to withdrawing funds from the originating account to ensure that, after withdrawn from the originating account, the remaining originating account balance is above a predetermined minimum. In some embodiments, process 1000 may only determine whether the originating account, after withdrawing the amount specified in the captured originating account information, would yield an originating account balance of greater than zero (i.e., a non-negative balance). In some embodiments, a predetermined minimum may be set at some amount greater than zero to ensure that the originating account has some funds leftover. The predetermined minimum may be set by a system administrator and may be updated at any time by the system administrator.

If interim step 1010 returns as false, i.e., there are not sufficient funds in the originating account, process 1000 may proceed to step 1020. At step 1020, process 1000 may send a rejection message to the user holding the originating account about the attempted transfer of funds. A rejection message may involve displaying on a computerized device that a transfer of funds could not be completed. A rejection message may include details about the attempted transaction, including time of attempted transfer, name of transferring party, attempted originating account, and an attempted destination account. A rejection message may be sent by any manner of contacting the user holding the originating account holder. For example, a user may have a specified email address or account with the financial institution holding the originating account. If process 1000 runs and returns an insufficient funds rejection at step 1010, then a user may receive an email regarding the rejection. The user may also receive a message in his or her account message board, viewable via web browser or mobile application, associated with the financial institution that notices the failed funds transfer.

If interim step 1010 returns as true, i.e., there are sufficient funds in the originating account, process 1000 may proceed to step 1030. At step 1030, process 1000 may complete the proposed transfer of funds, withdrawing an amount specified from the originating account and depositing the equivalent amount into the destination account. For example, after process 1000 establishes a connection between an originating account and a destination account and determines that sufficient funds exist in the originating account, process 1000 may transfer the funds to the destination account.

At step 1040, process 1000 ends. After completing a transfer of funds to the destination account, any connection between the originating account and the destination account may cease.

It is to be understood that in some embodiments, the steps of the corresponding process are not necessarily performed according to the sequence shown in FIG. 10 and described in the present disclosure. In some other embodiments, process 1000 may include more or fewer steps than those described in the present disclosure. In addition, a single step described in the present disclosure may be divided into a plurality of steps for description in other embodiments; and a plurality of steps described in the present disclosure may also be combined into a single step for description in other embodiments.

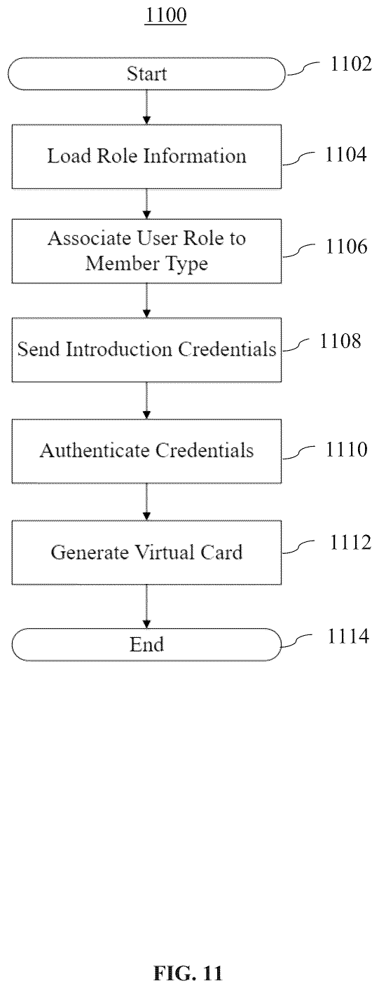

FIG. 11 is a diagram of an exemplary process 1100 for facilitating an initial role assignment of participants within the digital system, consistent with disclosed embodiments. Participants in an organization may have one of many roles within the organization. Certain processes or actions may become available or become disabled based on the user role associated to a participant.

At step 1102, process 1100 may start. Process 1100 may be start automatically or after manual intervention. Process 1100 may start automatically where a new participant becomes associated with an organization using the system. After a new participant association occurs, process 1100 may start to ensure the new participant is assigned a role and verified. For example, a university using the system may have provide virtual cards to students enrolled at the university. Students need to have roles defined for their respective virtual card accounts, so that after a new student enrolls at the university, process 1100 may start to provide a role and verify the new student's credentials. Process 1100 may also start after manual intervention such as when an existing participant is associated to a new team account. Association to a new team account or virtual card may then start process 1100 to update the existing participant's role. For example, an existing student at a university using the system may join a sports team. After a university administrator manually enters information regarding the existing student's new participation on the sports team, process 1100 may start to provide an updated role and verify the new student's credentials. Roles and verification of student credentials are discussed more fully in other portions of this disclosure.

At step 1104, process 1100 may load role information. Role information may refer to certain views and actions accessible to participants based on the various roles of an organization using the digital system. Roles of an organization may refer to the functions or duties associated with a person in an organization. For example, roles may include a system administrator role. System administrator roles may have the highest credentials in the system, with total access and modification controls to all functionalities and capabilities of the system. All views and actions may be accessible to and modified by a participant with a system administrator role.

Process 1100 may load any number of additional roles as defined by an organization using the system. Additional roles may include roles that govern a corporate account, that govern at least one team account, or that govern at least one virtual card. As further examples, roles may also include other teams associated with an organization itself, such as a university club, or other individual participants within the larger organization, such as a university club president. For example, process 1100, implemented for a university sports team, may associate a participant as managing funds for a specific sports team, or process 1100 may associate a participant as a member of a specific sports team. Organizations may define what views and actions are accessible to and modified by each role used within the system. Thus, the association of a role to a participant may affect the views and actions the participant may access and/or modify.

At step 1106, process 1100 may associate a user role to a new participant. In some embodiments, step 1106 may occur automatically. As a non-limiting example, an organization may have a certain domain name email address reserved for certain user roles so that when a new participant joins the organization, process 1100 may automatically assign a user role to the participant based on the domain name of the email address. For example, a new participant may be a student registered at a university with a domain address such as “university@student.edu.” The domain address “student.edu” may indicate to process 1100 to programmatically assigns the role of a student user to the new participant based on the domain address. In some embodiments, step 1006 may occur through manual intervention of other system participants. Manual intervention may include assigning a participant to a user role through a computerized device or mobile application. For example, an existing participant may have a list of new participants to assign amongst several user roles and may assign each new participant a role. In some embodiments, once an association occurs, the association determines a new participant's access controls. In some embodiments, access controls may determine what information a participant has access to.

As a non-limiting example, participants assigned a user role with a higher level of access controls may be able to review certain information or reports that is not accessible to those with a lower level of access controls. Such access controls may grant (or deny) a participant's ability to view certain information. Information may include a detailed view of all transactions that utilized a virtual card associated with a corporate account, a detailed view of past, current, or previous events, a detailed view of team account budgets, or a detailed view of individual participants associated with a corporate account. For example, a university may define a college administrator and student athlete as two unique user roles within process 1100. In some embodiments, a university may decide the college administrator role has a higher level of access controls than a student athlete user role. If a participant is associated with the college administrator role, then that participant may have options to view and to modify budgets for an upcoming calendar year. If, however, a participant is associated with the student athlete role, then that participant may have no access to view or to modify any team budgets for an upcoming calendar year.

For participants assigned a user role with a higher level of access controls, the participants may be able to make modifications within the system, consistent with disclosed embodiments. In some embodiments, those with a lower level of access controls may not be able to make any changes. In other embodiments, those with a lower level of access controls may be able to make some modifications, consistent with disclosed embodiments. Modifications may refer to updates by a participant within a database of a digital system, as described with respect to FIG. 5. For example, a participant with a higher level of access controls may have override capabilities for accepting or denying a budget proposal from a participant with a lower level of access controls. In some embodiments, a participant may have options to update certain information, such as individual participant's names, contact information (including but not limited to emails, organization unique identifiers (IDs), and telephone numbers), the status of budget proposals or requests, or ancillary details, such as free text entry for further explanation of budget requests. As a non-limiting example, process 1100 may associate certain participants with certain roles to ensure certain participants can review all budget proposals within a university system. A participant associated with such a user role may update any participant's information within a university's system. In some embodiments, access controls may be limited by certain groups of participants. For example, a university system may assign user roles with access controls over unique teams, such as individual sports teams, or clubs, such as a university club or organization. It is to be understood that any combination of access controls may be implemented with the technology described herein.

At step 1108, process 1100 may send initial credentials to new participants for authentication. Sending initial credentials may include any method of delivering unique system identification information to a new participant. Unique system identification information may refer to any combination of information that may be used to authenticate a user's identity, such as username and password combinations. As a non-limiting example, after step 1106, process 1100 at step 1108 may send an automated email to all new participants detailing an assigned user roles with a link for each new participant to authenticate their credentials before being able to use their respective virtual cards.

At step 1110, process 1110 may authenticate the credentials of new participant. Authentication may occur in any of the ways as previously disclosed with respect to FIG. 5. Authentication may occur through verification of a new participant's credentials. For example, verification may include providing a new participant's requisite username and password through a mobile application or web browser. In some embodiments, an organization may require two-factor authentication or biometric authentication at step 1110. Two-factor authentication may include a security system with at least two distinct forms of identification before verification of a new participant's credentials is complete. For example, a new participant may provide an initial username and password to login and verify her credentials. An organization using two-factor authentication may send the participant an email with a secondary passcode to enter into a secondary screen display on a mobile application or web browser for entry as a means of further verifying the participant's credentials. Biometric authentication may include a security system that uses a participant's biological traits as a form of identification before verification of a new participant's credentials is complete. Biological traits may include data stored on a mobile device or computerized device that may include fingerprints, retinal scan, or facial structures. In some embodiments, process 1100 at step 1110 may require a new participant to authenticate their new credentials within a set time period. The set time period for a new participant to authenticate their new credentials may be predetermined and updated to match a security level authentication protocol of the organization.

After authentication occurs at step 1110, process 1100 may proceed to step 1112. At step 1112, process 1100 may generate a new virtual card. In some embodiments, the new virtual card may be associated with the new participant. In some embodiments, generating a virtual card may include creating a unique account number, a unique pin, and associating the new participant's information to the virtual card. In some embodiments, associating the new virtual card with the new participant may include associating a 16-digit account number of the virtual card with the new participant's least name and email address.

After generating a virtual card, process 1100 for adding a new participant may end at step 1114.

It is to be understood that in some embodiments, the steps of the corresponding process are not necessarily performed according to the sequence shown in FIG. 11 and described in the present disclosure. In some other embodiments, process 1100 may include more or fewer steps than those described in the present disclosure. In addition, a single step described in the present disclosure may be divided into a plurality of steps for description in other embodiments; and a plurality of steps described in the present disclosure may also be combined into a single step for description in other embodiments.

The present disclosure has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

According to some embodiments, the operations, techniques, and/or components described herein can be implemented by a device or system, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that can incorporate hard-wired and/or program logic to implement the techniques and other features of the present disclosure.

The one or more special-purpose computing devices can be generally controlled and coordinated by operating system software, such as iOS, Android, Blackberry, Chrome OS, Windows XP, Windows Vista, Windows 7, Windows 8, Windows Server, Windows CE, Unix, Linux, SunOS, Solaris, VxWorks, or other compatible operating systems. In other embodiments, the computing device can be controlled by a proprietary operating system. Operating systems can control and schedule computer processes for execution, perform memory management, provide file system, networking, I/O services, and provide a user interface functionality, such as a graphical user interface (“GUI”), among other things.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps.

It is intended, therefore, that the specification and examples be considered as example only, with a true scope and spirit being indicated by the following claims and their full scope of equivalents.

1-20. (canceled)

21. A system comprising:
a memory storing a set of instructions;
a processor, in electronic communication with the memory, configured to execute the instructions to:
associate a participant with an institution based on an access right of the user, wherein the access right is used to authenticate the user with the institution and a determination that the participant has at least one account associated with the institution;
receive a request to retrieve an amount of funds from the at least one account to a participant virtual card;
verify sufficient funds in the at least one account based on the request;
upon determining that insufficient funds exist:
validate an association between the at least one account and a corporate account associated with the institution;
receive an automatic fund transfer request to transfer the amount of funds from the corporate account to the at least one account;
verify the automatic fund transfer request against a fund allocation policy associated with the corporate account;
upon determining that the automatic fund transfer request does not comply with the fund allocation policy, automatically cancel the request; and
upon determining that the automatic fund transfer request complies with the fund allocation policy:
automatically transfer the amount of funds from the corporate account to the at least one account; and
update the sufficient funds verification to determine that sufficient funds exist; and
upon determining sufficient funds exist, automatically transfer the amount of funds from the at least one account to the participant virtual card.

22. The system of claim 21, wherein the participant virtual card is associated with a tracing system to track total funds on the participant virtual card.

23. The system of claim 21, wherein the participant virtual card is a wallet application with contactless card capabilities.

24. The system of claim 21, wherein the automatic transfer of the amount of funds is limited based on rules associated with the institution.

25. The system of claim 21, wherein the at least one account is one of a checking account or a savings account.

26. The system of claim 21, wherein the instructions are further configured to cause the processor to send for display, on a participant device, a mobile application configured to display confirmation of the automatic transfer of the amount of funds.

27. The system of claim 26, wherein the mobile application is configured to display confirmation of insufficient funds.

28. The system of claim 26, wherein the mobile application is configured to store the participant virtual card.

29. The system of claim 21, wherein the participant virtual card is used at point of sale transactions.

30. The system of claim 21, wherein the request is to transfer funds through a second virtual card to the participant virtual card.

31. The system of claim 21, wherein the participant virtual card stores payment and credentialling information.

32. The system of claim 21, wherein the institution is configured to manage distribution of funds to the participant virtual card, wherein the managing further includes at least one of calculating changes in the distribution of funds, determining the distribution of funds for participants within the same institution, or accommodating the distribution of funds from multiple sources to the participant virtual card.

33. The system of claim 32, wherein the institution has at least one of a policy, limit, or rule associated with the distribution of funds.

34. The system of claim 21, further including updating a database based on an update to at least one of: a participant status, a value of the amount of funds, or an update to the at least one virtual card.

35. The system of claim 21, wherein the participant virtual card is associated with more than one participant.

36. The system of claim 21, wherein the participant virtual card is associated with only one participant.

37. The system of claim 21, wherein the participant virtual card is limited for use in certain transactions.

38. The system of claim 21, wherein the participant virtual card is associated with a policy that limits an amount of funds that are spent within a specific time period.

39. A computer-implemented method for transferring funds to a participant virtual card, comprising:
associating a participant with an institution based on an access right of the user, wherein the access right is used to authenticate the user with the institution and a determination that the participant has at least one account associated with the institution;
receiving a request to retrieve an amount of funds from the at least one account to the participant virtual card;
verifying sufficient funds in the at least one account based on the request;
upon determining that insufficient funds exist:
validate an association between the at least one account and a corporate account associated with the institution;
receive an automatic fund transfer request to transfer the amount of funds from the corporate account to the at least one account;
verify the automatic fund transfer request against a fund allocation policy associated with the corporate account;
upon determining that the automatic fund transfer request does not comply with the fund allocation policy, automatically cancel the request; and
upon determining that the automatic fund transfer request complies with the fund allocation policy:
automatically transfer the amount of funds from the corporate account to the at least one account; and
update the sufficient funds verification to determine that sufficient funds exist; and
upon determining sufficient funds exist, automatically transfer the amount of funds from the at least one account to the participant virtual card.

40. A tangible, non-transitory computer-readable memory device that stores a set of instructions that, when executed by at least one processor, cause the at least one processor to perform operations for transferring funds to a participant virtual card comprising:
associate a participant with an institution based on an access right of the user, wherein the access right is used to authenticate the user with the institution and a determination that the participant has at least one account associated with the institution;
receiving a request to retrieve an amount of funds from the at least one account to the participant virtual card;
verifying sufficient funds in the at least one account based on the request;
upon determining that insufficient funds exist:
validate an association between the at least one account and a corporate account associated with the institution;
receive an automatic fund transfer request to transfer the amount of funds from the corporate account to the at least one account;
verify the automatic fund transfer request against a fund allocation policy associated with the corporate account;
upon determining that the automatic fund transfer request does not comply with the fund allocation policy, automatically cancel the request; and
upon determining that the automatic fund transfer request complies with the fund allocation policy:
automatically transfer the amount of funds from the corporate account to the at least one account; and
update the sufficient funds verification to determine that sufficient funds exist; and
upon determining sufficient funds exist, automatically transfer the amount of funds from the at least one account to the participant virtual card.
